(19) United States
(12) Patent Application Publication
(10) Pub. No.: US 2026/0363282 A1
(43) Pub. Date: Nov. 19, 2026

(54) EGG WHITE SUBSTITUTE USING LEGUMES AND METHOD FOR MANUFACTURING THE SAME

(71) Applicant: JOINANDJOIN INC., Jeonju-Si, Jeonbuk-Do (KR)

(72) Inventors: Haesu JIN, Ansan-si (KR); Min Gyeong GWON, Changwon-si (KR); Jeong Min CHOI, Seoul (KR); Eun Jeong JO, Anyang-si (KR)

(73) Assignee: JOINANDJOIN INC., Jeonju-Si, Jeonbuk-Do (KR)

(21) Appl. No.: 19/132,190

(22) PCT Filed: Dec. 27, 2024
(86) PCT No.: PCT/KR2024/021338

§ 371 Date: May 22, 2025

(30) Foreign Application Priority Data
Dec. 28, 2023 (KR) 10-2023-0194425
Jan. 23, 2024 (KR) 10-2024-0010208
Jan. 23, 2024 (KR) 10-2024-0010209
Jan. 23, 2024 (KR) 10-2024-0010213
Jan. 23, 2024 (KR) 10-2024-0010215
Jan. 23, 2024 (KR) 10-2024-0010217
Jan. 23, 2024 (KR) 10-2024-0010220

(51) Int. Cl. A23L 11/50; A21D 2/36; A23B 2/40; A23G 3/48; A23J 1/14; A23L 15/00

(52) U.S. Cl. CPC A23L 11/50; A21D 2/362; A23B 2/40; A23G 3/48; A23J 1/148; A23L 15/35

(57) ABSTRACT

The present invention relates to a method for manufacturing aquafaba using legumes and to the aquafaba manufactured by the method. The aquafaba manufactured by the method of the present invention has a high protein content and excellent foam overrun and stability. Further, according to the present invention, even people with egg allergies will be able to enjoy desserts using aquafaba without worry. In addition, the legume byproducts generated after manufacturing aquafaba can be made into snacks through food upcycling.

### FIELD OF INVENTION

The present invention relates to an egg white substitute using legumes and a method for manufacturing the same, and more specifically, to aquafaba that can be used as an egg white substitute.

### BACKGROUND OF INVENTION

Aquafaba, a vegetable protein substitute for egg whites and egg white powder, which are widely used in the food industry, is a combination of the Latin word “aqua” meaning water and “faba” meaning bean, and refers to a bean water that comes out after boiling chickpeas, lentils, etc. It is a food that attracts attention as a substitute for eggs, which is useable by vegetarians, such as lacto-vegetarians who do not eat eggs or meat, and vegans who do not eat dairy products. Further, people with egg allergies can also enjoy desserts using aquafaba without worry.

Aquafaba can replace egg whites used in making dessert dough. When whipping aquafaba with a whisk for about 5 minutes, it will turn into a creamy texture like meringue or whipped cream. Therefore, it can be used in vegetable mayonnaise, salad dressing, baking, etc. Owing to low calories, it draws attention as a diet food and can be used in the process of making ‘vegan desserts’ free of milk or butter.

In the present invention, a method for producing aquafaba as an egg white substitute using legumes was developed, and the egg white substitute aquafaba produced by the method of the present invention has a high protein content and excellent foam overrun and stability. Further, the legume byproducts generated after producing aquafaba can be made into various snacks through food upcycling.

### SUMMARY OF INVENTION

### Technical Problem to be Solved

An object of the present invention to solve the above problems is to provide an egg white substitute using legumes.

Another object of the present invention is to provide a method for manufacturing an egg white substitute.

### Technical Solution

In order to achieve the above purpose, the present invention provides an aquafaba food composition comprising legumes, purified water, enzymes, pH adjusters and thickeners as effective ingredients,
wherein the above legumes are chickpeas, black beans, small black beans, soybeans or white kidney beans,
the above purified water is added in an amount of 4 to 6 times the weight of the legumes,
the above enzyme is a mixed enzyme of beta-glucanase, cellulase, hemicellulase and xylanase, a mixed enzyme of cellulase and hemicellulase, a xylanase enzyme or a cellulase enzyme,
the above pH adjuster is phosphoric acid, tartaric acid, lactic acid, citric acid or malic acid, and
the thickener is one or more selected from the group consisting of xanthan gum, carrageenan, dextrin, guar gum, gellan gum, locust bean gum, pectin, methylcellulose (MC) and hydroxypropyl methylcellulose.

In one embodiment of the present invention, the “aquafaba food composition” may include, but is not limited to, 16 to 20 wt. % of legumes, 78 to 84 wt. % of purified water, 0.3 to 1.2 wt. % of enzymes, 0.10 to 0.12 wt. % of pH adjuster, and 0.03 to 0.07 wt. % of thickener, and particularly, 18 to 20 wt. % of legumes, 78 to 80 wt. % of purified water, 0.3 to 1.2 wt. % of enzymes, 0.10 to 0.12 wt. % of pH adjuster, and 0.03 to 0.07 wt. % of thickener.

In one embodiment of the present invention, the “aquafaba food composition” may have, but is not limited to, a pH of 4.4 to 6.0, a viscosity of 10 to 300 (cp), an overrun of 700 to 1200(%), and a foam stability of 80 to 100(%), and particularly, a pH of 4.4 to 4.6, a viscosity of 10 to 35 (cp), an overrun of 700 to 1200(%), and a foam stability of 80 to 100(%).

In one embodiment of the present invention, the “aquafaba food composition” may be prepared by treating the legumes with the enzyme to cause a reaction, and maturing them for 1 to 20 days after the enzyme is reacted, but is not limited thereto.

Further, in order to achieve the above purpose, the present invention provides a method for manufacturing aquafaba, comprising:
(step 1) a step of washing one of the legumes among chickpeas, black beans, small black beans (mouse-eye beans), soybeans, and white kidney beans;
(step 2) a step of mixing water 3 to 7 times the weight of the beans with the beans washed in step (1);
(step 3) a step of treating the water-mixed beans in step (2) with any one enzyme selected from the group consisting of \textcircled{1} a mixed enzyme of beta-glucanase, cellulase, hemicellulase, and xylanase, \textcircled{2} a mixed enzyme of cellulase and hemicellulase, \textcircled{3} a xylanase enzyme, and \textcircled{4} a cellulase enzyme, in an amount of 0.1 to 2 wt. % relative to the weight of the beans;
(step 4) a step of heating to 50 to 60 °C after treating the enzyme in step (3) above and reacting for 1 to 5 hours;
(step 5) a step of boiling by heating at 80 to 110 °C for 1 to 5 hours after reacting the enzyme in step (4);
(step 6) a step of maturing at 0 to 5 °C for 1 to 20 days after boiling in step (5);
(step 7) after maturation in the step (6), a step of adjusting to pH 4 to 5 by adding any one pH adjuster of phosphoric acid, tartaric acid, lactic acid, citric acid, and malic acid, and then, adding one or more thickener selected from the group consisting of xanthan gum, guar gum, gellan gum, locust bean gum, carrageenan, pectin, MC (methylcellulose), and HPMC (hydroxypropyl methylcellulose) at 0.1 to 0.5 wt. % to the final product;
(step 8) a step of producing aquafaba through steps (1) to (7) above; and
(step 9) a step of sterilizing the produced aquafaba at 110~130 °C and 1~2 atm for 30 minutes to 2 hours.

In addition, in order to achieve the above objects, the present invention provides aquafaba produced by the above manufacturing method.

### Effect of Invention

The present invention relates to a method for manufacturing an egg white substitute using legumes and to an egg white substitute, that is, aquafaba, manufactured by the method. The aquafaba as an egg white substitute manufactured by the method of the present invention has a high protein content and excellent foam overrun and stability. Therefore, according to the present invention, even people with egg allergies can enjoy desserts using aquafaba without worry. Further, legume byproducts generated after producing aquafaba may also be used to manufacture snacks through food upcycling.

Effects obtainable from embodiments of the present invention are not particularly limited to those described above, and such other effects not mentioned herein could be obviously deduced and understood by those skilled in the art based on the following detailed description.

### BRIEF DESCRIPTION OF DRAWINGS

The following drawings included as a part of the detailed description to assist understanding for the embodiments, would provide various embodiments and illustrate technical features of the various embodiments as well as the detailed description.

FIG. 1 is a diagram showing a step for producing aquafaba as an egg white substitute in one embodiment of the present invention.

FIG. 2 is a diagram showing the degree of swelling of chickpeas to temperature and time in the soaking step during the production of aquafaba in one embodiment of the present invention.

FIG. 3 is a diagram showing the quality of aquafaba to the type of enzyme used in the enzyme treatment step during the production of aquafaba in one embodiment of the present invention.

FIG. 4 is a diagram showing the quality of the produced aquafaba to various weight ratios of chickpeas and purified water in the boiling step during the production of aquafaba in one embodiment of the present invention.

FIG. 5 is a diagram showing the quality of aquafaba to the type of pH adjuster in a pH adjuster adding step during the production of aquafaba in one embodiment of the present invention.

FIG. 6 is a diagram showing the quality of aquafaba to the type of thickener in the thickener adding step during the production of aquafaba in one embodiment of the present invention (6a; using enzyme \textcircled{1}, 6b; using enzyme \textcircled{2}, 6c; not using enzyme).

FIG. 7 is a diagram showing the quality of aquafaba according to whether sterilization (retort) is performed after the completion of aquafaba production in one embodiment of the present invention.

FIG. 8 is a diagram showing the results of microbial analysis of the produced aquafaba according to one embodiment of the present invention.

FIG. 9 is a diagram showing the quality of aquafaba to the type of legume used in the production of aquafaba in one embodiment of the present invention.

FIG. 10 is a diagram showing the quality of aquafaba to the type of legume and the addition of a pH adjuster during the production of aquafaba in one embodiment of the present invention.

FIG. 11 is a diagram showing the quality of aquafaba to the type of legume and the addition of a pH adjuster/thickener during the production of aquafaba in one embodiment of the present invention.

FIG. 12 is a diagram showing the result of applying the produced aquafaba to a product according to one embodiment of the present invention.

FIG. 13 is a diagram showing cookies manufactured using chickpea by-products remaining in the production of aquafaba according to one embodiment of the present invention.

### CONCRETE DESCRIPTION OF PREFERRED EMBODIMENTS OF INVENTION

Hereinafter, the present invention will be described in detail with reference to the attached drawings as embodiments of the present invention. However, the following embodiments are presented as illustrative examples of the present invention, and if it is judged that a detailed description of a technology or configuration well known to those skilled in the art may unnecessarily obscure the gist of the present invention, the detailed description thereof may be omitted, and the present invention is not limited thereby. The present invention is capable of various modifications and applications within the scope of the following claims and equivalents interpreted therefrom.

Further, the terms used in this specification are terms used to appropriately express preferred embodiments of the present invention, and may vary depending on the intention of the user or operator, or the customs of the field to which the present invention belongs. Therefore, the definitions of these terms should be made based on the contents throughout this specification. Throughout the specification, when a part is said to “include” a certain component, this does not mean that other components are excluded, but rather that other components can be further included, unless specifically stated otherwise.

Throughout this specification, ‘%’ used to indicate the concentration of a particular substance, unless otherwise stated, is (w/w) % for solid/solid, (w/v) % for solid/liquid, and (v/v) % for liquid/liquid.

### <Preparation Example> Manufacturing Method of Egg White Substitute

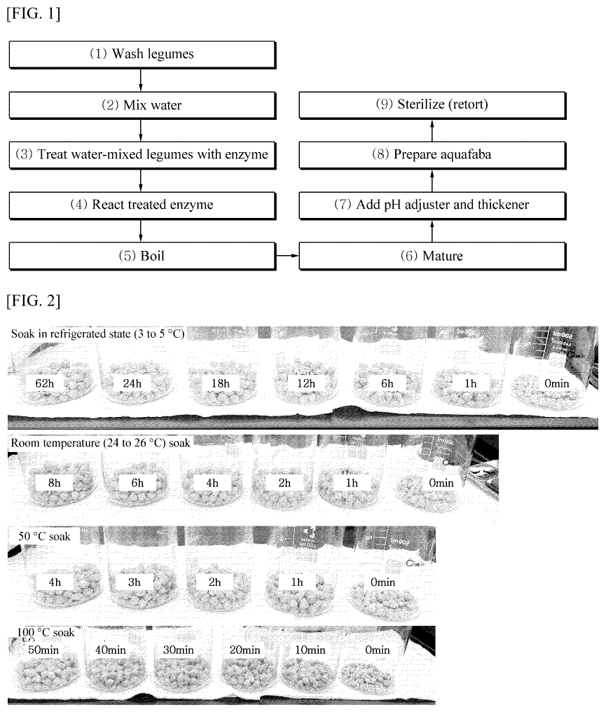

In order to produce aquafaba as an egg white substitute of the present invention, the following process was established (see FIG. 1).
(1) Step of washing the legumes; specifically, any one of chickpeas, black beans, small black beans (mouse-eye beans), soybeans, and white kidney beans may be washed 1 to 3 times, and chickpeas may be used preferably.
(2) Step of soaking the legumes in water; The legumes washed in step (1) may be mixed with water in an amount of 3 to 7 times the weight of the legumes, preferably, water may be mixed in an amount of 4 to 6 times the weight of the legumes. Further, after water mixing, the legumes may be soaked in water at 1 to 100 °C for 40 minutes to 62 hours (at this time, in regard to the time to the temperature, this process is performed until the weight of the legumes is doubled).
(3) Step of treating the soaked beans with an enzyme; specifically, the enzyme for treatment at this time may be any one of \textcircled{1} a mixture of Beta-glucanase, Cellulase, Hemicellulase and Xylanase of Novozymes, \textcircled{2} a mixture of Cellulase and Hemicellulase, \textcircled{3} Xylanase, and \textcircled{4} Cellulase, and preferably, \textcircled{1} Da mixture of Beta-glucanase, Cellulase, Hemicellulase and Xylanase, or \textcircled{2} a mixture of Cellulase and Hemicellulase and, at this time, the enzyme relative to the weight of the legumes may be used for treatment in an amount of 0.3~1.2 wt. %, specifically, 0.1~2 wt. %.
(4) Step of reacting the treated enzyme; specifically, the enzyme of step (3) is treated on the water-added legumes, heated to 50 to 60 °C, and reacted for 1 to 5 hours. More preferably, the reaction is performed at 52 to 58 °C for 2 to 4 hours while, mixing once every 20 to 30 minutes and, rest of the time, the reactor may be closed with a lid to maintain an isothermal state.
(5) Boiling step; specifically, after the enzymatic reaction of step (4), it may be boiled at 80 to 110 °C for 1 to 5 hours. At this time, it may be heated at 90 to 100 °C for 1 to 4 hours, and more preferably, it can be heated at 95 to 100 °C for 1 to 3 hours.
(6) Maturation step; specifically, the maturation may be performed at 0 to 5 °C for 1 to 20 days, preferably for 2 to 12 days, and more preferably for 3 to 11 days.
(7) Step of adding a pH adjuster and a thickener; specifically, as a pH adjuster, any one of phosphoric acid, tartaric acid, lactic acid, citric acid and malic acid is used to adjust the pH to 4 to 5. Further, 0.1 to 0.5 wt. % of one of xanthan gum, carrageenan, dextrin, guar gum, gellan gum, locust bean gum, pectin, MC and HPMC may be added as a thickener in an amount of 0.03 to 1.0 wt. %, preferably 0.1 to 0.5 wt. %.

According to one embodiment, the pH adjuster used herein may be any one of phosphoric acid, tartaric acid, lactic acid, citric acid and malic acid to adjust the pH to 4.4 to 6.0, while the thickener used herein may be any one of xanthan gum, carrageenan and dextrin to be added in an amount of 0.03 to 1.0 wt. %. Specifically, the thickener may be 0.1 to 0.2 wt. % of xanthan gum, 0.15 to 0.3 wt. % of carrageenan and 0.15 to 0.5 wt. % of dextrin to be added.

According to one embodiment, the pH adjuster used herein may be citric acid, lactic acid or malic acid to adjust pH to 4.3 to 4.8, while the thickener may be xanthan gum or guar gum to be added in an amount of 0.2 to 0.4 wt. %.

According to one embodiment, the pH adjuster used herein may be citric acid, lactic acid or malic acid to adjust pH to 4.3 to 4.8, while the thickener may be xanthan gum or guar gum to be added in an amount of 0.2 to 0.4 wt. %.
(8) Step of producing aquafaba through steps (1) to (7) above.
(9) Step of sterilizing (retorting) the produced aquafaba; specifically, sterilizing may be performed at 110 to 130 °C and 1 to 2 atm for 30 minutes to 2 hours, and preferably, sterilizing may be performed at 115 to 125 °C and 1.2 to 1.7 atm for 30 minutes to 1 hour.

### <Experimental Example 1> Test to Confirm Optimal Conditions of Legumes

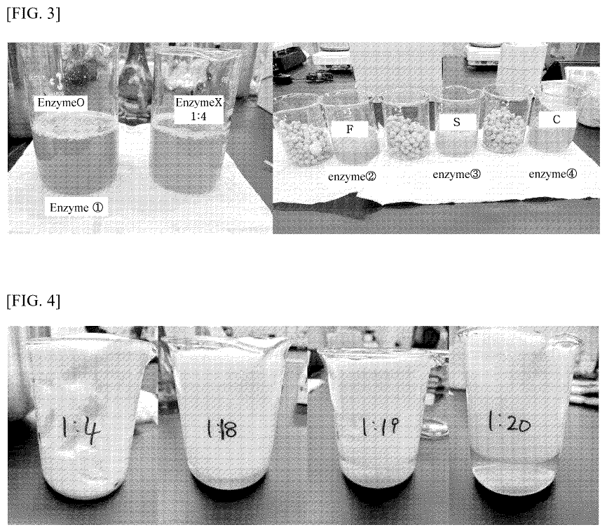

When soaking the legumes in water in step (2) of the above preparation example, the degree of swelling of the legumes was checked according to the soaking time. At this time, 50 g of dried chickpeas were used in the experiment. A picture of the swollen chickpeas is shown in FIG. 2.

50 g of chickpeas were soaked in low temperature (1~5 °C) water, room temperature (23~26 °C) water, medium temperature (48~52 °C) water, or high temperature (98~102 °C) water, respectively. In order to find the optimal conditions, the condition was set when the legumes were about twice as swollen. The results are shown in Table 1 below.

TABLE 1

| | Temperature (°C) | | | | | |
|---|---|---|---|---|---|---|
| | Water at low temperature (1 to 5 °C) | | | | | |
| Soaking time (h) | 1 | 6 | 12 | 18 | 24 | 62 |
| Dried chickpea (g) | 50 | 50 | 50 | 50 | 50 | 50 |
| Soaked chickpea (g) | 69 | 89 | 96 | 101 | 102 | 102 |

| | Temperature (°C) | | | | |
|---|---|---|---|---|---|
| | Water at room temperature (23 to 26 °C) | | | | |
| Soaking time (h) | 1 | 2 | 4 | 6 | 8 |
| Dried chickpea (g) | 50 | 50 | 50 | 50 | 50 |
| Soaked chickpea (g) | 50 | 88 | 92 | 101 | 103 |

| | Temperature (°C) | | | |
|---|---|---|---|---|
| | Water at middle temperature (48 to 52 °C) | | | |
| Soaking time (h) | 1 | 2 | 3 | 4 |
| Dried chickpea (g) | 50 | 50 | 50 | 50 |
| Soaked chickpea (g) | 88 | 92 | 102 | 103 |

| | Temperature (°C) | | | | |
|---|---|---|---|---|---|
| | Water at high temperature (98 to102 °C) | | | | |
| Soaking time (min) | 10 | 20 | 30 | 40 | 50 |
| Dried chickpea (g) | 50 | 50 | 50 | 50 | 50 |
| Soaked chickpea (g) | 80 | 88 | 92 | 100 | 100 |

### <Experimental Example 2> Test to Confirm Optimal Conditions in Enzyme Treatment Stage

### 2-1. Protein Content Test by Enzyme Treatment

In the step of treating the water-mixed legumes with enzymes (3) of the above preparation example, the increase in protein content in aquafaba and the quality of aquafaba were compared depending on the enzyme for treatment. The treatment enzymes were any one among \textcircled{1} mixture of Beta-glucanase, Cellulase, Hemicellulase, and Xylanase, \textcircled{2} a mixture of Cellulase and Hemicellulase, \textcircled{3} Xylanase, and \textcircled{4} Cellulase, which are obtainable from Novozymes Co., and the carbohydrate and protein contents in aquafaba were compared by treating with the above enzyme (in the case of treatment using a mixture, treatment was done at the same mixing ratio). The carbohydrate and protein contents were confirmed in the form of g contained per 100 g of aquafaba and are shown in Table 2 below. The enzyme treated at this time is 0.4 wt. % to the weight of legumes and pure water.

TABLE 2

| | | Hydrocarbonate | Protein |
|---|---|---|---|
| Test items | | (g/100 g) | (g/100 g) |
| Control | Enzyme non-treatment | 2.88 | 0.88 |
| | group | | |
| Enzyme\textcircled{1} | A mixture of beta- | 3.11 | 5.81 |
| treatment (V) | glucanase, cellulase, | | |
| | hemicellulase and | | |
| | xylanase | | |
| Enzyme\textcircled{2} | A mixture of cellulase | 3.21 | 6.72 |
| treatment (F) | and hemicellulose | | |
| Enzyme\textcircled{3} | Xylanase | 2.94 | 1.07 |
| treatment (S) | | | |
| Enzyme\textcircled{4} | Cellulase | 2.88 | 0.88 |
| treatment (C) | | | |

As can be found in Table 2 above, it was confirmed that the group treated with an enzyme comprising \textcircled{1} a mixture of beta-glucanase, cellulase, hemicellulase and xylanase or \textcircled{2} a mixture of cellulase and hemicellulase had a higher protein content compared to the control group.

### 2-2. Aquafaba Quality Test to Enzyme Treatment Type

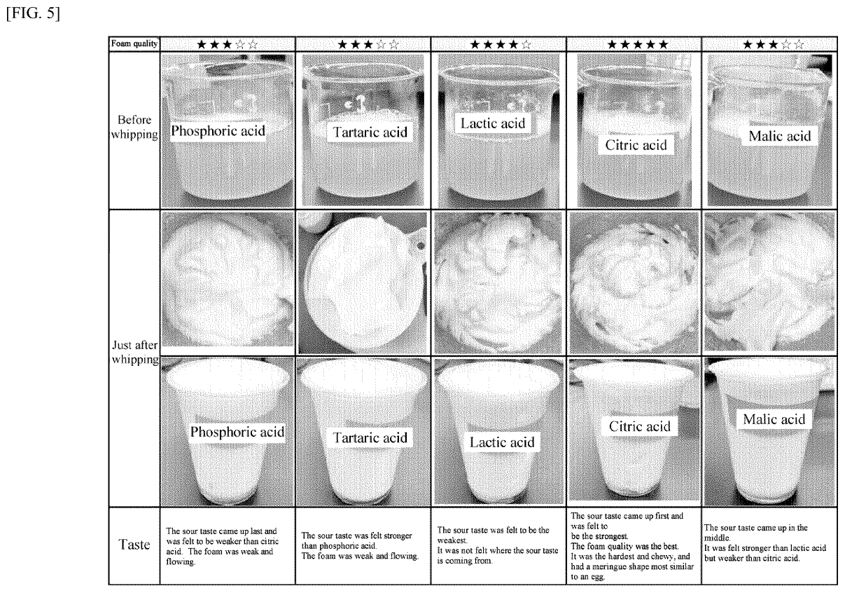

In order to verify the quality of aquafaba to the type of enzyme treatment, the remaining process was carried out identically with only the enzyme type being different. The quality of aquafaba was measured for pH, Bx, and viscosity, and the foaming performance was measured for overrun (%) and the foam stability was measured for syneresis rate (%). At this time, in order to determine whether the enzyme was effective, a test was conducted by treating a high concentration of enzyme at 10 wt. % based on the dried legumes, and the results are shown in Table 3 below (see FIG. 3).

Meanwhile, overrun is a value that indicates how much the volume increases by % due to stirring. In simple terms, it is a value that indicates the increase in the volume of the material due to mixing of air. This is used as an indicator of foaming performance.

TABLE 3

| | | Enzyme\textcircled{1} | | | |
|---|---|---|---|---|---|
| | | (mixture of | | | |
| | | beta- | | | |
| | | glucanase, | Enzyme\textcircled{2} | | |
| | No use of | cellulase, | (mixture of | | |
| | enzyme | hemicellulose | cellulase and | Enzyme\textcircled{3} | Enzyme\textcircled{4} |
| | (enzyme X) | and xylanase) | hemicellulose) | (xylanase) | (cellulase) |
| pH | 6.16 | 6.05 | 5.92 | 5.99 | 5.98 |
| Bx | 4.56 | 5.18 | 5.29 | 4.69 | 5.36 |
| Viscosity (cp) | 3.24 | 3.24 | 3.48 | 3.42 | 4.8 |
| Overrun (%) | 695.40 | 813.49 | 738.63 | 618.78 | 647.53 |
| Foam stability | 94.95 | 95.50 | 92.50 | 81.60 | 89.50 |
| (syneresis | | | | | |
| rate, %) | | | | | |

As can be found in Table 3 above, when treated with enzyme 0 or enzyme @, it was confirmed that the foaming performance (overrun) and foam stability (syneresis rate) were much better than those of aquafaba produced without using enzyme and aquafaba produced by treating enzyme \textcircled{3} or enzyme \textcircled{4}.

### 2-3. Aquafaba Quality Test According to Enzyme Treatment Concentration

Through the test of the above 2-2, the enzyme was determined as enzyme 0 or enzyme @, and then an aquafaba quality test was conducted according to the enzyme concentration. At this time, 0.04 wt. %, 0.2 wt. %, 0.4 wt. %, 1.19 wt. % or 1.96 wt. % to the total weight of the dried legumes were compared. The results are shown in Table 4 below.

TABLE 4

| | Enzyme | | | | | | | | | | |
|---|---|---|---|---|---|---|---|---|---|---|---|
| | Not | Enzyme\textcircled{1} (mixture of beta-glucanase | | | | | Enzyme\textcircled{2} (mixture of cellulase | | | | |
| | used | cellulase, hemicellulose and xylanase) | | | | | and hemicellulose) | | | | |
| Dried | 20 | 19.99 | 19.96 | 19.92 | 19.76 | 19.61 | 19.99 | 19.96 | 19.92 | 19.76 | 19.61 |
| chickpea | | | | | | | | | | | |
| (wt. %) | | | | | | | | | | | |
| Purified | 80 | 79.97 | 79.84 | 79.68 | 79.05 | 78.45 | 79.97 | 79.84 | 79.66 | 79.05 | 78.43 |
| water | | | | | | | | | | | |
| (wt. %) | | | | | | | | | | | |
| Enzyme | — | 0.04 | 0.2 | 0.4 | 1.19 | 1.96 | 0.04 | 0.2 | 0.4 | 1.19 | 1.96 |
| (wt. %) | | | | | | | | | | | |

<Test result>

| | | | | | | | | | | | |
|---|---|---|---|---|---|---|---|---|---|---|---|
| pH | 6.16 | 6.28 | 6.19 | 6.19 | 6.1 | 6.02 | 6.14 | 6.15 | 6.12 | 6.11 | 6.04 |
| Bx | 4.56 | 3.52 | 3.46 | 3.42 | 4.37 | 4.59 | 3.58 | 3.73 | 4.12 | 4.32 | 4.8 |
| Viscosity | 3.24 | 11.58 | 8.46 | 11.58 | 3.96 | 4.74 | 3.42 | 3.42 | 3.78 | 3.48 | 3.42 |
| (cp) | | | | | | | | | | | |
| Overrun | 695.4 | 891.98 | 899.91 | 991.64 | 792.58 | 872.98 | 581.83 | 721.05 | 686.02 | 1,183.65 | 1,051.76 |
| (%) | | | | | | | | | | | |
| Foam | 94.95 | 99.40 | 99.80 | 100.00 | 96.00 | 95.50 | 84.40 | 99.30 | 86.90 | 99.80 | 95.90 |
| stability | | | | | | | | | | | |
| (syneresis | | | | | | | | | | | |
| rate, %) | | | | | | | | | | | |

As shown in the results in Table 4 above, the results of the concentration test using the two enzymes \textcircled{1} or \textcircled{2}, which attained good results in the previous experiment, showed that the result values were different for each enzyme at different working concentrations. In particular, in the case of enzyme \textcircled{1}, it was confirmed that the group added with 0.4 wt. % enzyme was the best, and in the case of enzyme \textcircled{2}, it was confirmed that the group added with 1.19 wt. enzyme was the best.

### <Experimental Example 3> Test to Confirm the Optimal Ratio of Legumes and Water During the Boiling Stage

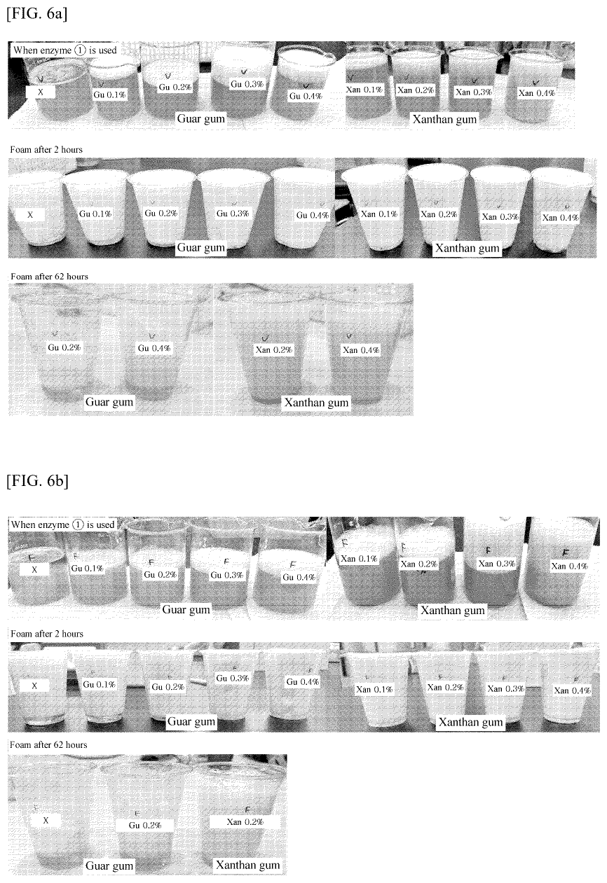

Next, in the case where extraction is conducted with changing the ratio of legumes and water (in step (5)), the quality of aquafaba thereby was confirmed (see FIG. 4). The results are shown in Table 5 below.

TABLE 5

| | Ratio (wt. ratio) | | | | | | | | | | | | |
|---|---|---|---|---|---|---|---|---|---|---|---|---|---|
| | 1:1 | 1:2 | 1:3 | 1:4 | 1:5 | 1:6 | 1:7 | 1:9 | 1:12 | 1:15 | 1:18 | 1:19 | 1:20 |
| Dried | 50 | 33.3 | 25 | 20 | 16.7 | 14.3 | 12.5 | 10 | 7.7 | 6.3 | 5.3 | 5 | 4.76 |
| chickpea | | | | | | | | | | | | | |
| (wt. %) | | | | | | | | | | | | | |
| Purified | 50 | 66.7 | 75 | 80 | 83.3 | 85.7 | 87.5 | 90 | 92.3 | 93.7 | 94.5 | 95 | 95.24 |
| water | | | | | | | | | | | | | |
| (wt. %) | | | | | | | | | | | | | |

<Test result>

| | | | | | | | | | | | | | |
|---|---|---|---|---|---|---|---|---|---|---|---|---|---|
| pH | — | — | 6.07 | 5.9 | 6.15 | 5.97 | 6.32 | 6.4 | 6.19 | 6.78 | 6.39 | 6.84 | 6.86 |
| Bx | — | — | 5.52 | 3.57 | 3.53 | 2.49 | 2.78 | 2.3 | 2.22 | 2.16 | 2.1 | 2.05 | 2.01 |
| Viscosity | — | — | 3.42 | 3.66 | 2.82 | 2.22 | 2.88 | 3 | 1.68 | 2.76 | 1.62 | — | — |
| (cp) | | | | | | | | | | | | | |
| Overrun | — | — | 718.81 | 695.40 | 686.32 | 676.17 | 644.23 | 594.07 | 588.96 | 559.84 | 553.32 | 501.28 | 486.81 |
| (%) | | | | | | | | | | | | | |
| Foam | — | — | 88.30 | 94.95 | 94.25 | 91.25 | 89.60 | 84.15 | 58.65 | 50.80 | 43.55 | 42.75 | 42.45 |
| stability | | | | | | | | | | | | | |
| (syneresis | | | | | | | | | | | | | |
| rate, %) | | | | | | | | | | | | | |

As can be found in Table 5 above, it could be confirmed that, as the weight ratio of the legumes gradually is reduced, the values of overall data such as foam stability and overrun decreased. Further, in the case of 1:1 and 1:2, the amount of water was too little and aquafaba was not produced. That is, referring to the experimental results above, it was confirmed that the optimal ratio of legumes and water was preferably 1:3 to 1:6, and in particular, 1:4 was most desirable.

### <Experimental Example 4> Test to Confirm the Optimal Maturation Period During Maturation

Next, in the maturing step (6), the remaining processes were carried out in the same manner with different maturation periods, and the quality of the aquafaba thereby was confirmed. The results are shown in Table 6 below.

TABLE 6

| | Maturation period | | | | | |
|---|---|---|---|---|---|---|
| | 0 day | 3 days | 5 days | 10 days | 12 days | 17 days |
| Dried | 19.92 | 19.92 | 19.92 | 19.92 | 19.92 | 19.92 |
| chickpea | | | | | | |
| (wt. %) | | | | | | |
| Purified | 79.68 | 79.68 | 79.68 | 79.68 | 79.68 | 79.68 |
| water | | | | | | |
| (wt. %) | | | | | | |
| Enzyme\textcircled{1} | 0.4 | 0.4 | 0.4 | 0.4 | 0.4 | 0.4 |
| used | | | | | | |

<Test result>

| | | | | | | |
|---|---|---|---|---|---|---|
| pH | 6.14 | 6.25 | 6.31 | 6.16 | 6.52 | 6.45 |
| Bx | 4.4 | 4.68 | 4.66 | 4.70 | 4.76 | 5.06 |
| Overrun (%) | 727.35 | 891.40 | 993.30 | 968.16 | 962.21 | 826.99 |
| Foam | 99.90 | 100.00 | 100.00 | 100.00 | 100.00 | 100.00 |
| stability | | | | | | |
| (syneresis | | | | | | |
| rate, %) | | | | | | |

As can be found in Table 6 above, excellent aquafaba quality was observed when maturing for 3 to 10 days, but after 11 days of maturing, it was confirmed that deterioration of the aquafaba began to occur and the foam quality deteriorated.

### <Experimental Example 5> Test to Confirm Optimal Conditions at the pH Adjuster Addition Stage

### 5-1. Aquafaba Quality Test to pH Adjuster Type

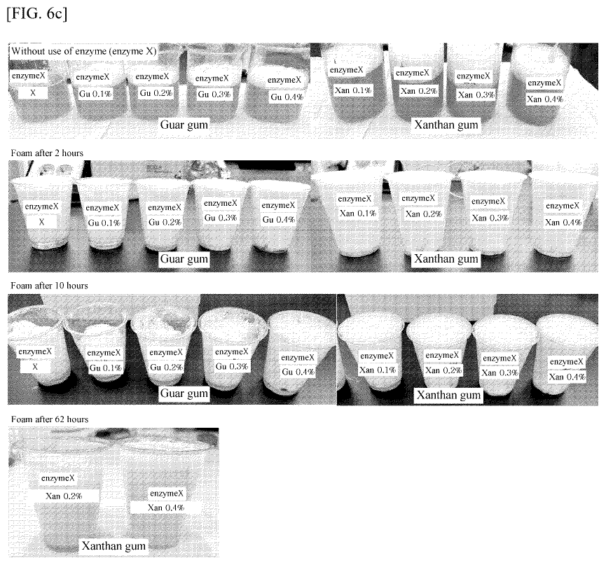

Next, in step (7), that is, the pH adjuster addition step, the remaining processes were carried out in the same manner with different types of pH adjusters, and the quality of aquafaba thereby was confirmed. The results are shown in Table 7 below (see FIG. 5).

TABLE 7

| | pH adjuster | | | | |
|---|---|---|---|---|---|
| | Phosphoric | Tartaric | Lactic | Citric | Malic |
| | acid | acid | acid | acid | acid |
| Dried chickpea | 19.98 | 19.98 | 19.97 | 19.98 | 19.98 |
| (wt. %) | | | | | |
| Purified water | 79.90 | 79.91 | 79.87 | 79.92 | 79.90 |
| (wt. %) | | | | | |
| pH adjuster | 0.12 | 0.11 | 0.16 | 0.1 | 0.12 |

<Test result>

| | | | | | |
|---|---|---|---|---|---|
| pH | 4.64 | 4.69 | 4.68 | 4.69 | 4.69 |
| Bx | 5.03 | 5.1 | 5.09 | 5.09 | 5.09 |
| Viscosity (cp) | 24.54 | 12.96 | 33.18 | 58.26 | 37.2 |
| Overrun (%) | 803.75 | 717.82 | 689.98 | 683.94 | 687.96 |
| Foam stability | 92.00 | 95.35 | 99.10 | 98.50 | 89.45 |
| (syneresis | | | | | |
| rate, %) | | | | | |

As can be found in the above Table 7, the group including lactic acid and citric acid pH adjusters added thereto showed excellent aquafaba quality. Further, as confirmed in FIG. 5, when phosphoric acid was used as a pH adjuster, the sour taste came up last and was felt to be weaker than citric acid, and the foam was weak and flowing. When tartaric acid was used as a pH adjuster, the sour taste was felt stronger than phosphoric acid, and the foam was weak and flowing. When lactic acid was used as a pH adjuster, the sour taste was felt to be the weakest, and it was not felt where the sour taste is coming from. Further, when citric acid was used as a pH adjuster, the sour taste came up first and was felt to be the strongest, and the foam quality was the best, and it was confirmed to be the hardest and chewy. In particular, when citric acid was added, it had a meringue shape most similar to an egg. When malic acid was used as a pH adjuster, it was confirmed that the sour taste came up in the middle, felt stronger than lactic acid but weaker than citric acid.

### 5-2. Aquafaba Quality Test According to Enzyme and pH Adjuster Treatment

Next, in step (7), that is, the pH adjuster addition step, citric acid was used as the pH adjuster, and the quality of aquafaba was checked according to whether it was treated with enzymes (enzyme (i or enzyme (treatment). The results are shown in Table 8 below.

TABLE 8

| | Enzyme used | | | | | |
|---|---|---|---|---|---|---|
| | Enzyme\textcircled{1} | | | | | |
| | (mixture of | | | | | |
| | beta-glucanase, | | Enzyme\textcircled{2} | | | |
| | cellulase, | | (mixture of | | | |
| | hemicellulose | | cellulase and | | | |
| | and xylanase | | hemicellulose) | | Enzyme X | |
| Dried | 19.9 | 19.92 | 19.74 | 19.76 | 19.98 | 20 |
| chickpea | | | | | | |
| (wt. %) | | | | | | |
| Purified | 79.6 | 79.68 | 79.97 | 79.05 | 79.91 | 80 |
| water | | | | | | |
| (wt. %) | | | | | | |
| Enzyme | 0.4 | 0.4 | 1.18 | 1.19 | 0 | 0 |
| (wt. %) | | | | | | |
| pH adjuster | 0.1 | 0 | 0.11 | 0 | 0.11 | 0 |
| (citric acid) | | | | | | |

<Test result>

| | | | | | | |
|---|---|---|---|---|---|---|
| pH | 4.6 | 6.3 | 4.6 | 6.2 | 4.6 | 6.38 |
| Bx | 4.51 | 4.36 | 4.77 | 4.85 | 4.1 | 4.07 |
| Overrun (%) | 1,080.55 | 877.36 | 997.37 | 957.75 | 942.03 | 903.94 |
| Foam | 100.00 | 99.35 | 100.00 | 97.00 | 100.00 | 98.75 |
| stability | | | | | | |
| (syneresis | | | | | | |
| rate, %) | | | | | | |

As can be found in Table 8 above, the overrun and foam stability of the product adjusted to pH 4.6 using a pH adjuster were higher than those that were not adjusted. Among them, it was confirmed that the group using a mixture of beta-glucanase, cellulase, hemicellulase and xylanase (enzyme \textcircled{1}) as an enzyme, as well as citric acid as a pH adjuster, has the best quality.

### <Experimental Example 5> Test to Confirm Optimal Conditions at the Thickener Addition Stage

### 5-1. Comparison Test of Aquafaba Foam Quality by Thickener Type

Next, in order to compare the quality of aquafaba foam according to the addition of different types of thickeners (hydrocolloid) in step (7) of the preparation example, xanthan gum, guar gum, gellan gum, locust bean gum, carrageenan or pectin was used as a natural additive, while MC (methylcellulose) or HPMC (hydroxypropyl methylcellulose) were used as a chemical synthetic additive. The experimental groups and the results of their overrun and foam stability are shown in Table 9 below.

TABLE 9

| Natural additives | | | Chemical synthetic additives | | |
|---|---|---|---|---|---|
| | | Foam | | | Foam |
| | | stability | | | stability |
| | Overrun | (syneresis | | Overrun | (syneresis |
| Type and weight | (%) | rate, %) | Type and weight | (%) | rate, %) |
| Xanthan gum | 501.746 | 99.41 | MC 0.05 wt. % | 747.03 | 85.90 |
| 0.05 wt. % | | | | | |
| Xanthan gum | 538.43 | 95.53 | MC 0.15 wt. % | 793.11 | 89.87 |
| 0.15 wt. % | | | | | |
| Xanthan gum | 677.08 | 100 | MC 0.30 wt. % | 677.08 | 93.66 |
| 0.30 wt. % | | | | | |
| Guar gum 0.05 | 611.89 | 99.81 | HPMC 0.05 | 631.16 | 82.29 |
| wt. % | | | wt. % | | |
| Guar gum 0.15 | 582.23 | 97.37 | HPMC 0.15 | 668.67 | 90.26 |
| wt. % | | | wt. % | | |
| Guar gum 0.30 | 661.53 | 100 | HPMC 0.30 | 713.21 | 90.28 |
| wt. % | | | wt. % | | |
| Gellan gum 0.05 | 683.31 | 87.25 | | | |
| wt. % | | | | | |
| Gellan gum 0.15 | 653.02 | 84.13 | | | |
| wt. % | | | | | |
| Gellan gum 0.30 | 661.07 | 89.79 | | | |
| wt. % | | | | | |
| Locust bean | 520.81 | 88.73 | | | |
| gum 0.05 wt. % | | | | | |
| Locust bean | 583.31 | 84.39 | | | |
| gum 0.15 wt. % | | | | | |
| Locust bean | 449.92 | 89.66 | | | |
| gum 0.30 wt. % | | | | | |
| Carrageenan | 621.66 | 81.86 | | | |
| 0.05 wt. % | | | | | |
| Carrageenan | 621.72 | 81.25 | | | |
| 0.15 wt. % | | | | | |
| Carrageenan | 625.62 | 76.70 | | | |
| 0.30 wt. % | | | | | |
| Pectin 0.05 wt. % | 752.09 | 87.81 | | | |
| Pectin 0.15 wt. % | 683.14 | 87.52 | | | |
| Pectin 0.30 wt. % | 510.91 | 91.13 | | | |

As can be found from the results shown in Table 9 above, when xanthan gum or guar gum was added at 0.3 wt. %, the highest overrun and foam stability were confirmed, which exhibited the shape of a solid foam that did not collapse even when turned over. Further, when considering the overrun and foam stability of all additives, the order of excellent effects was confirmed to be xanthan gum>guar gum>>gellan gum=pectin=locust bean gum=HPMC=MC>carrageenan.

### 5-2. Test to Confirm Optimal Conditions at the Thickener Addition Stage

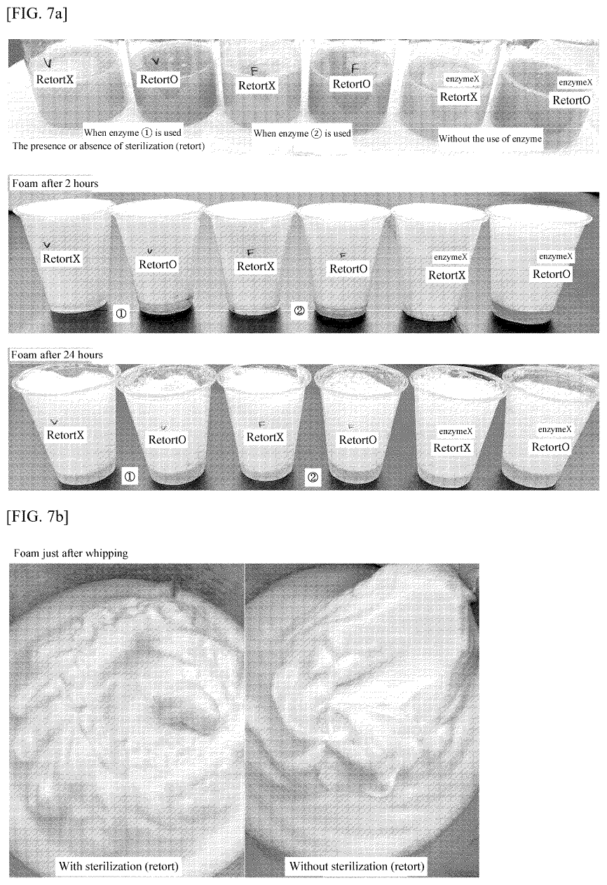

Next, in step (7), that is, the thickener addition step, the remaining processes were carried out in the same manner with different types of thickeners, and the quality of aquafaba thereby was confirmed (see FIGS. 6a to 6c, 6a; enzyme \textcircled{1} used, 6b; enzyme \textcircled{2} used, 6c; enzyme not used). The results are shown in Tables 10 to 12 below.

TABLE 10

| | thickener | | | | | | | | |
|---|---|---|---|---|---|---|---|---|---|
| | No use | Guar gum | | | | Xanthan gum | | | |
| Dried | 19.9 | 18.89 | 18.88 | 18.87 | 18.86 | 18.89 | 18.88 | 18.87 | 18.86 |
| chickpea | | | | | | | | | |
| (wt. %) | | | | | | | | | |
| Purified | 79.6 | 79.56 | 79.52 | 79.49 | 79.45 | 79.56 | 79.52 | 79.49 | 79.45 |
| water | | | | | | | | | |
| (wt. %) | | | | | | | | | |
| Enzyme \textcircled{1} | 0.4 | 0.4 | 0.4 | 0.4 | 0.4 | 0.4 | 0.4 | 0.4 | 0.4 |
| (wt. %) | | | | | | | | | |
| pH adjuster | 0.11 | 0.11 | 0.11 | 0.11 | 0.11 | 0.11 | 0.11 | 0.11 | 0.11 |
| (citric acid) | | | | | | | | | |
| (wt. %) | | | | | | | | | |
| Thickener | — | 0.05 | 0.09 | 0.14 | 0.19 | 0.05 | 0.09 | 0.14 | 0.19 |
| (wt. %) | | | | | | | | | |

<Test result>

| | | | | | | | | | |
|---|---|---|---|---|---|---|---|---|---|
| pH | 4.64 | 4.62 | 4.62 | 4.62 | 4.62 | 4.62 | 4.61 | 4.60 | 4.62 |
| Bx | 4.72 | 4.84 | 5.01 | 5.06 | 5.09 | 5.29 | 5.40 | 5.44 | 5.58 |
| Viscosity | 17.52 | 29.88 | 84.60 | 115.6 | 287.4 | 53.28 | 2122 | 10520 | 16920 |
| (cp) | | | | | | | | | |
| Overrun | 1,071.43 | 838.32 | 788.29 | 842.65 | 843.20 | 769.08 | 771.97 | 900.97 | 847.90 |
| (%) | | | | | | | | | |
| Foam | 100.00 | 100.00 | 100.00 | 100.00 | 100.00 | 100.00 | 100.00 | 100.00 | 100.00 |
| stability | | | | | | | | | |
| (syneresis | | | | | | | | | |
| rate, %) | | | | | | | | | |

TABLE 11

| | thickener | | | | | | | | |
|---|---|---|---|---|---|---|---|---|---|
| | No use | Guar gum | | | | Xanthan gum | | | |
| Dried | 19.94 | 19.73 | 19.72 | 19.71 | 19.71 | 19.73 | 19.72 | 19.71 | 19.71 |
| chickpea | | | | | | | | | |
| (wt. %) | | | | | | | | | |
| Purified | 78.97 | 78.93 | 78.90 | 78.86 | 78.82 | 78.93 | 78.90 | 78.86 | 78.82 |
| water | | | | | | | | | |
| (wt. %) | | | | | | | | | |
| Enzyme \textcircled{2} | 1.18 | 1.18 | 1.18 | 1.18 | 1.18 | 1.18 | 1.18 | 1.18 | 1.18 |
| (wt. %) | | | | | | | | | |
| pH adjuster | 0.11 | 0.11 | 0.11 | 0.11 | 0.11 | 0.11 | 0.11 | 0.11 | 0.11 |
| (citric acid) | | | | | | | | | |
| (wt. %) | | | | | | | | | |
| Thickener | — | 0.05 | 0.09 | 0.14 | 0.18 | 0.05 | 0.09 | 0.14 | 0.18 |
| (wt. %) | | | | | | | | | |

<Test result>

| | | | | | | | | | |
|---|---|---|---|---|---|---|---|---|---|
| pH | 4.57 | 4.52 | 4.51 | 4.5 | 4.5 | 4.63 | 4.65 | 4.65 | 4.61 |
| Bx | 5.06 | 5.23 | 5.28 | 5.4 | 5.47 | 5.07 | 5.15 | 5.1 | 5.26 |
| Viscosity | 21.36 | 26.4 | 73.92 | 94.32 | 290.7 | 54.12 | 104.5 | 5262 | 12750 |
| (cp) | | | | | | | | | |
| Overrun | 1,039.5 | 786.02 | 775.37 | 741.90 | 661.81 | 843.37 | 859.16 | 783.62 | 696.46 |
| (%) | | | | | | | | | |
| Foam | 100.00 | 100.00 | 100.00 | 100.00 | 100.00 | 100.00 | 100.00 | 100.00 | 100.00 |
| stability | | | | | | | | | |
| (syneresis | | | | | | | | | |
| rate, %) | | | | | | | | | |

TABLE 12

| | thickener | | | | | | | | |
|---|---|---|---|---|---|---|---|---|---|
| | No use | Guar gum | | | | Xanthan gum | | | |
| Dried | 19.98 | 19.97 | 19.96 | 19.95 | 19.94 | 19.97 | 19.96 | 19.95 | 19.94 |
| chickpea | | | | | | | | | |
| (wt. %) | | | | | | | | | |
| Purified | 79.91 | 79.88 | 79.84 | 79.80 | 79.77 | 79.88 | 79.84 | 79.80 | 79.77 |
| water | | | | | | | | | |
| (wt. %) | | | | | | | | | |
| Enzyme X | — | — | — | — | — | — | — | — | — |
| pH adjuster | 0.11 | 0.11 | 0.11 | 0.11 | 0.11 | 0.11 | 0.11 | 0.11 | 0.11 |
| (citric acid) | | | | | | | | | |
| (wt. %) | | | | | | | | | |
| Thickener | — | 0.05 | 0.09 | 0.14 | 0.19 | 0.05 | 0.09 | 0.14 | 0.19 |
| (wt. %) | | | | | | | | | |

<Test result>

| | | | | | | | | | |
|---|---|---|---|---|---|---|---|---|---|
| Ph | 4.72 | 4.7 | 4.7 | 4.7 | 4.68 | 4.76 | 4.75 | 4.71 | 4.68 |
| Bx | 5.09 | 5.19 | 5.28 | 5.34 | 5.42 | 5.89 | 6.05 | 6.19 | 6.25 |
| Viscosity | 5.1 | 192.6 | 261 | 439.2 | 5022 | 219.9 | 597.6 | 5340 | 15630 |
| (cp) | | | | | | | | | |
| Overrun | 833.77 | 841.59 | 878.71 | 831.89 | 709.09 | 799.78 | 810.36 | 806.76 | 724.62 |
| (%) | | | | | | | | | |
| Foam | 100.00 | 100.00 | 100.00 | 100.00 | 100.00 | 100.00 | 100.00 | 100.00 | 100.00 |
| stability | | | | | | | | | |
| (syneresis | | | | | | | | | |
| rate, %) | | | | | | | | | |

As can be found in Tables 10 to 12 above, it was confirmed that the quality of aquafaba is improved when adding a thickener. However, as can be seen in FIGS. 6a to 6c, it was confirmed that the foam did not disappear in the sample containing xanthan gum even after 2 hours, and it was also confirmed that the foam did not disappear compared to the other sample groups even after 10 hours and 62 hours.

### <Experimental Example 6> Comparison Test of Foam Quality According to Sterilization Process

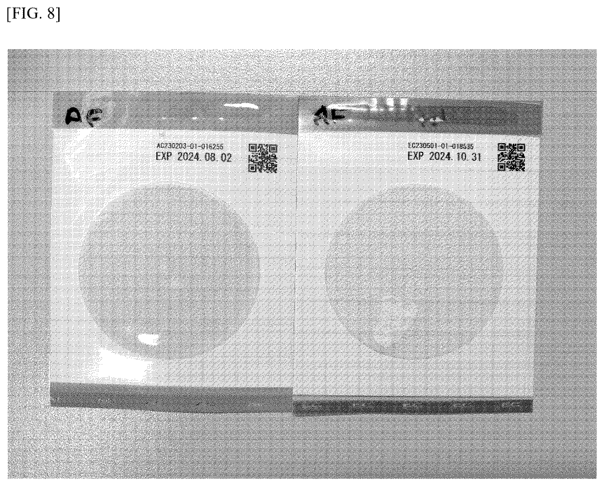

Next, in the retort sterilization process step (9), the quality of aquafaba foam was compared depending on whether or not it was sterilized. If sterilization is conducted, all microorganisms in the product are sterilized, thus allowing the product to be distributed at room temperature. This was done to check whether or not quality deteriorated due to protein denaturation, etc. in the product as a result of high-temperature and high-pressure sterilization. Sterilization was conducted by heat-treating the sealed product at a central temperature of 120 °C and 1.5 atm for 3 minutes to 1 hour, or by a method with equivalent or higher effects, after placing it in an airtight container or package. At this time, the remaining processes were performed in the same manner, with differences in the type of enzyme and in the presence or absence of sterilization. The results are shown in Table 13 below (see FIG. 7).

TABLE 13

| | Enzyme used | | | | | |
|---|---|---|---|---|---|---|
| | Enzyme\textcircled{1} | | | | | |
| | (mixture of | | | | | |
| | beta-glucanase, | | Enzyme\textcircled{2} | | | |
| | cellulase, | | (mixture of | | | |
| | hemicellulose | | cellulase and | | | |
| | and xylanase | | hemicellulose) | | Enzyme X | |
| Sterilization | X | O | X | O | X | O |
| Dried | 19.89 | 19.89 | 19.73 | 19.73 | 19.97 | 19.97 |
| chickpea | | | | | | |
| (wt. %) | | | | | | |
| Purified | 79.56 | 79.56 | 78.93 | 78.93 | 79.88 | 79.88 |
| water | | | | | | |
| (wt. %) | | | | | | |
| Enzyme | 0.4 | 0.4 | 1.18 | 1.18 | — | — |
| (wt. %) | | | | | | |
| pH adjuster | 0.11 | 0.11 | 0.11 | 0.11 | 0.11 | 0.11 |
| (citric acid) | | | | | | |
| (wt. %) | | | | | | |
| Thickener | 0.05 | 0.05 | 0.05 | 0.05 | 0.05 | 0.05 |
| (xanthan gum) | | | | | | |
| (wt. %) | | | | | | |

<Test result>

| | | | | | | |
|---|---|---|---|---|---|---|
| pH | 4.56 | 4.49 | 4.48 | 4.44 | 4.48 | 4.46 |
| Bx | 5.39 | 5.39 | 5 | 4.97 | 4.99 | 5.01 |
| Viscosity | 31.86 | 13.68 | 37.86 | 15.84 | 22.98 | 10.68 |
| Overrun (%) | 739.23 | 831.07 | 763.59 | 771.71 | 799.42 | 788.34 |
| Foam | 100.00 | 100.00 | 100.00 | 100.00 | 100.00 | 100.00 |
| stability | | | | | | |
| (syneresis | | | | | | |
| rate, %) | | | | | | |

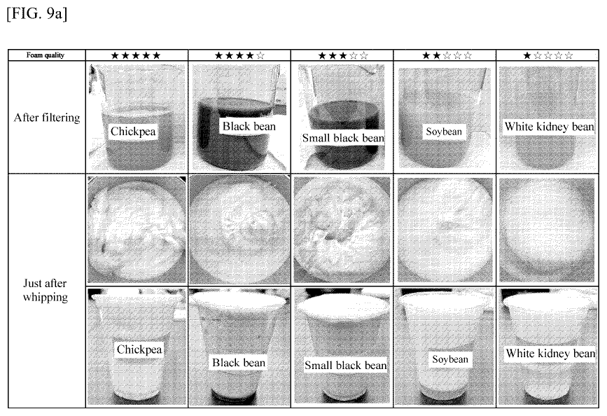

As can be found in the above Table 13 and FIG. 7, pores of the foam were larger in the case where retort was carried out than in the case where retort was not carried out, however, there was no significant difference in the quality index depending on whether retort was carried out or not. This is because the product was affected after retort due to protein denaturation when heated at high temperature and high pressure, but it was confirmed that there was no significant effect on the product quality even after sterilization as a result of controlling it through the optimal combination of pH adjusters, thickeners, etc. Further, the results of the microbial test of aquafaba after sterilization are shown in FIG. 8. FIG. 8 (left) shows general bacteria while FIG. 8 (right) shows Escherichia coli, confirming that general bacteria and Escherichia coli were not detected. In other words, in the sterilized product, the microbial vegetative cells and spores were killed, which means that the vegetative cells of the aquafaba were killed after sterilization.

### <Experimental Example 7> Quality Comparison Test of Aquafaba to Legume Type

### 7-1. Tests by Type of Legumes

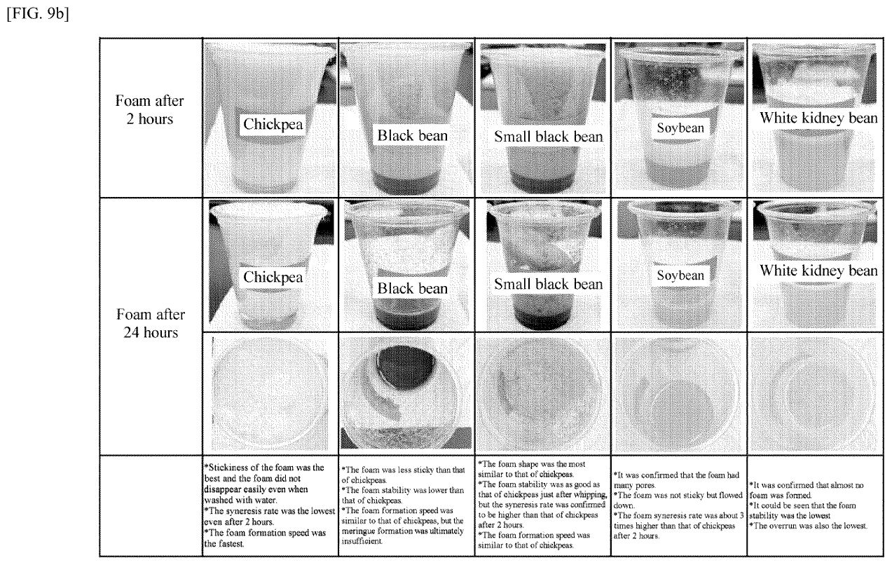

The manufacturing method established by the above Experimental Examples 1 to 6 (excluding the pH adjuster and thickener) was applied to other legumes such as kernel green black bean (‘black bean’), Rhynchosia nulubilis (‘small black bean’; called mouse-eye bean), soybean or white kidney bean, and compared with aquafaba produced from chickpeas (see FIG. 9). The results are shown in Table 14 below.

TABLE 14

| | Type of legumes | | | | |
|---|---|---|---|---|---|
| | | | Small | | White |
| | | Black | black | | kidney |
| | Chickpea | bean | bean | soybean | bean |
| Dried legumes | 20 | 20 | 20 | 20 | 20 |
| (wt. %) | | | | | |
| Purified water | 80 | 80 | 80 | 80 | 80 |
| (wt. %) | | | | | |

<Test result>

| | | | | | |
|---|---|---|---|---|---|
| pH | 6.08 | 5.98 | 6.04 | 6.03 | 6.01 |
| Bx | 5.65 | 5.18 | 5.24 | 5.12 | 4.13 |
| Overrun (%) | 819.28 | 714.03 | 773.58 | 612.22 | 149.49 |
| Foam stability | 100.00 | 86.15 | 99.00 | 82.70 | 11.75 |
| (syneresis | | | | | |
| rate, %) | | | | | |

As can be found in Table 14 and FIG. 9, stickiness of the foam was the best in the case of chickpeas, and the foam did not disappear easily even when washed with water. Further, the syneresis rate was the lowest even after 2 hours, and the foam formation speed was the fastest. In the case of black beans, the foam was less sticky than that of chickpeas. Further, the foam stability was lower than that of chickpeas, and the foam formation speed was similar to that of chickpeas, but the meringue formation was ultimately insufficient. In the case of small black beans, the foam shape was the most similar to that of chickpeas. Further, the foam stability was as good as that of chickpeas immediately after whipping, but the syneresis rate was confirmed to be higher than that of chickpeas after 2 hours. The foam formation speed was similar to that of chickpeas.

In the case of soybeans, it was confirmed that the foam had many pores. Further, the foam was not sticky but flowed down, and the foam syneresis rate was about 3 times higher than that of chickpeas after 2 hours. In the case of white kidney beans, it was confirmed that almost no foam was formed. Further, it could be seen that the foam stability was the lowest, and the overrun was also the lowest.

In other words, when looking at the foam stability, overrun, and foam quality of aquafaba as a whole, chickpea had the best quality. Therefore, chickpea was determined to be suitable as an egg white substitute based on the stickiness, foam pores, and foam formation speed.

However, since soybeans have a cleaner flavor than chickpeas while black beans and soybeans have a slight soy sauce flavor, it is believed that the legumes may be changed depending on the desired direction of the product.

### 7-2. Test According to Legume Type and pH Adjuster Addition

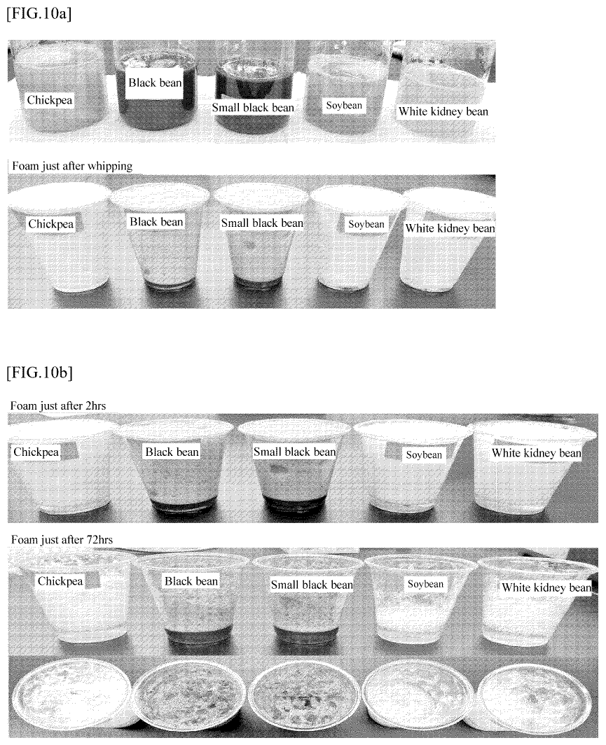

The manufacturing method established by the above Experimental Examples 1 to 6 (adding pH adjuster/excluding thickener) was applied to other legumes such as kernel green black bean (‘black bean’), Rhynchosia nulubilis (‘small black bean’; called mouse-eye bean), soybean or white kidney bean, and compared with aquafaba produced from chickpeas (see FIG. 10). The results are shown in Table 15 below.

TABLE 15

| | Type of legumes | | | | |
|---|---|---|---|---|---|
| | | Black | Small black | | White kidney |
| | Chickpea | bean | bean | Soybean | bean |
| Dried legumes | 19.97 | 19.97 | 19.97 | 19.97 | 19.97 |
| (wt. %) | | | | | |
| Purified water | 79.89 | 79.89 | 79.89 | 79.89 | 79.89 |
| (wt. %) | | | | | |
| pH adjuster | 0.13 | 0.13 | 0.13 | 0.13 | 0.13 |
| (citric acid) | | | | | |
| (wt. %) | | | | | |

<Test result>

| | | | | | |
|---|---|---|---|---|---|
| pH | 4.6 | 4.6 | 4.6 | 4.6 | 4.6 |
| Bx | 5.11 | 4.73 | 5.37 | 5.41 | 4.93 |
| Overrun (%) | 879.30 | 828.46 | 674.70 | 821.46 | 690.40 |
| Foam stability | 100.00 | 100.00 | 99.00 | 100.00 | 100.00 |
| (syneresis | | | | | |
| rate, %) | | | | | |

As can be found in Table 15 and FIG. 10, the syneresis rate of the chickpea foam was the lowest immediately after whipping. Further, after 72 hours, it could be seen that the foam in the soybean and white kidney bean completely disappeared. At this time, the disappearance status between the chickpea, black bean and small black bean was similar to one another.

### 7-3. Tests According to Types of Legumes and Addition of pH Adjuster and Thickener

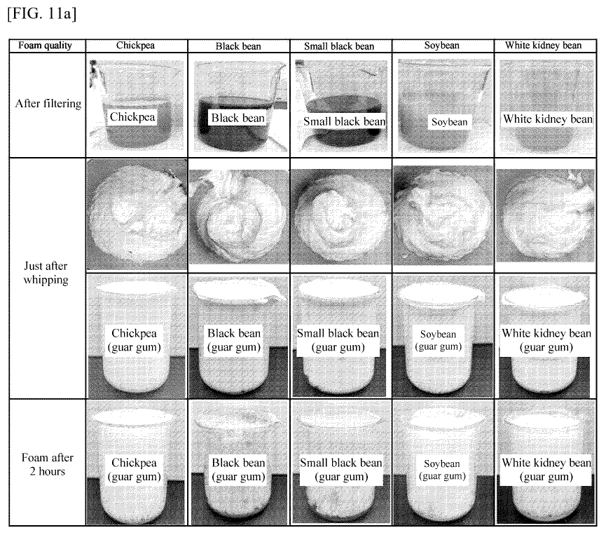

The manufacturing method (addition of pH adjuster/addition of thickener) established by the above Experimental Examples 1 to 6 was applied to other legumes such as kernel green black bean (‘black bean’), Rhynchosia nulubilis (‘small black bean’; called mouse-eye bean), soybean or white kidney bean, and compared with aquafaba produced from chickpeas (see FIG. 11). The results are shown in Table 16 below (using guar gum as a thickener) and Table 17 (using xanthan gum as a thickener).

TABLE 16

| | Type of legumes | | | | |
|---|---|---|---|---|---|
| | | Black | Small black | | White kidney |
| | Chickpea | bean | bean | Soybean | bean |
| Dried legumes | 19.95 | 19.95 | 19.95 | 19.95 | 19.95 |
| (wt. %) | | | | | |
| Purified water | 79.8 | 79.8 | 79.8 | 79.8 | 79.8 |
| (wt. %) | | | | | |
| pH adjuster | 0.11 | 0.11 | 0.11 | 0.11 | 0.11 |
| (citric acid) | | | | | |
| (wt. %) | | | | | |
| Thickener | 0.14 | 0.14 | 0.14 | 0.14 | 0.14 |
| (guar gum) | | | | | |
| (wt. %) | | | | | |

<Test result>

| | | | | | |
|---|---|---|---|---|---|
| pH | 4.6 | 4.6 | 4.6 | 4.6 | 4.6 |
| Bx | 6.02 | 5.21 | 5.26 | 5.41 | 4.39 |
| Viscosity | 10,630 | 6,516 | 1,650 | 1,848 | 149.4 |
| Overrun (%) | 1,051.69 | 995.28 | 1,347.06 | 965.86 | 712.42 |
| Foam stability | 100.00 | 100.00 | 100.00 | 100.00 | 100.00 |
| (syneresis | | | | | |
| rate, %) | | | | | |

TABLE 17

| | Type of legumes | | | | |
|---|---|---|---|---|---|
| | | | Small | | White |
| | | Black | black | | kidney |
| | Chickpea | bean | bean | Soybean | bean |
| Dried legumes | 19.97 | 19.97 | 19.97 | 19.97 | 19.97 |
| (wt. %) | | | | | |
| Purified water | 79.88 | 79.88 | 79.88 | 79.88 | 79.88 |
| (wt. %) | | | | | |
| pH adjuster | 0.11 | 0.11 | 0.11 | 0.11 | 0.11 |
| (citric acid) | | | | | |
| (wt. %) | | | | | |
| Thickener | 0.04 | 0.04 | 0.04 | 0.04 | 0.04 |
| (xanthan gum) | | | | | |
| (wt. %) | | | | | |

<Test result>

| | | | | | |
|---|---|---|---|---|---|
| pH | 4.6 | 4.6 | 4.6 | 4.6 | 4.6 |
| Bx | 5.8 | 5.15 | 5.11 | 5.21 | 4.21 |
| Viscosity | 994.5 | 300.6 | 362.4 | 479.4 | 21.54 |
| Overrun (%) | 833.23 | 777.94 | 838.22 | 749.45 | 718.91 |
| Foam stability | 100.00 | 100.00 | 100.00 | 100.00 | 100.00 |
| (syneresis | | | | | |
| rate, %) | | | | | |

As can be found from the above Tables 16, 17 and FIG. 11, when the manufacturing method of the present invention is applied to black beans, small black beans, soybeans and white kidney beans in addition to chickpeas, it was confirmed that effects similar to chickpeas were achieved, that is, the foam stability or overrun of aquafaba and the foam quality were improved.

### <Experimental Example 8> Manufacturing a Dessert Using the Produced Aquafaba

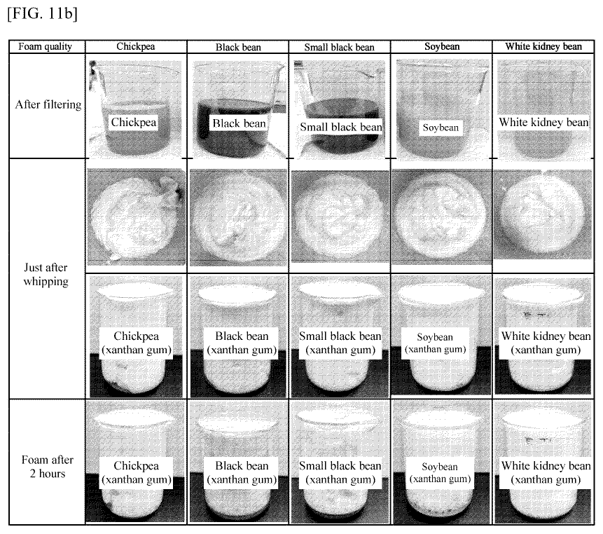

Using the aquafaba produced in the present invention, meringue cookies, macaron coques, sponge cakes, and gluten-free bread were manufactured (see FIG. 12). As can be seen in FIG. 12, it is believed that the aquafaba of the present invention can be applied to various products.

### <Experimental Example 9> Manufacturing Cookie Using Legume by-Products

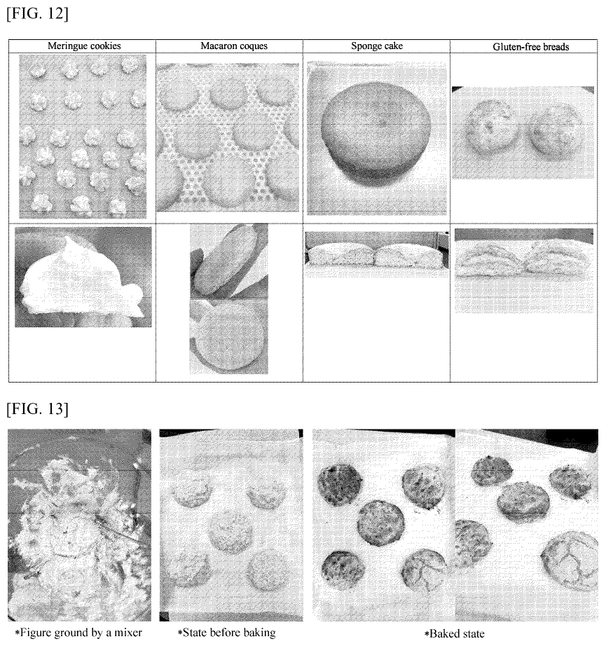

Cookies were manufactured using the by-product of legumes remaining in the production of aquafaba. The specific manufacturing method is as in the above preparation example, 300 parts by weight (‘wt. parts’) of the chickpea by-product (waste chickpea) remaining in the production of aquafaba was mixed with 40 wt. parts of almond butter, 50 wt. parts of honey, 5 ml of vanilla extract, 15 ml of olive oil and 7 wt. parts of baking powder, then ground finely using a mixer. After that, it was made into a cookie shape and baked using an oven to manufacture cookies (see FIG. 13).

### Preparation Example 2

TABLE 18

| Raw materials | Content (wt. %) |
|---|---|
| Chickpea extract | 99.5 |
| Lota carrageenan | 0.15 |
| Xanthan gum | 0.1 |
| Maltodextrin | 0.25 |
| Total | 100 |

As described above, specific embodiments of the present invention have been described in detail; however, those skilled in the art who understand the spirit of the present invention will be able to easily suggest other backward inventions or other embodiments included within the scope of the spirit of the present invention by adding, changing, deleting, etc. other components within the scope of the same spirit. Therefore, it should be understood that the embodiments described above are exemplary and not restrictive in all respects. The scope of the present invention is present by the scope of the claims described below rather than the detailed description described above, and all changes or modifications derived from the meaning and scope of the claims and the equivalent concept thereof should be interpreted as being included in the scope of the present invention.

1. An aquafaba food composition comprising legumes, purified water, enzyme, a pH adjuster and thickener as effective ingredients,
wherein the legumes are chickpeas, black beans, small black beans (mouse-eye beans), soybeans or white kidney beans,
the purified water is added in an amount of 4 to 6 times the weight of the legumes,
the enzyme is a mixed enzyme of beta-glucanase, cellulase, hemicellulase and xylanase; a mixed enzyme of cellulase and hemicellulose; a xylanase enzyme; or a cellulase enzyme,
the pH adjuster is phosphoric acid, tartaric acid, lactic acid, citric acid or malic acid, and
the thickener is one or more selected from the group consisting of xanthan gum, carrageenan, dextrin, guar gum, gellan gum, locust bean gum, pectin, methylcellulose (MC) and hydroxypropyl methylcellulose (HPMC).

2. The composition according to claim 1, wherein the aquafaba food composition includes 16 to 20 wt. % of legumes, 78 to 84 wt. % of purified water, 0.3 to 1.2 wt. % of enzymes, 0.10 to 0.12 wt. % of pH adjuster, and 0.03 to 1.0 wt. % of thickener.

3. The composition according to claim 1, wherein the aquafaba food composition has pH of 4.4 to 6.0, a viscosity of 10 to 300 (cp), an overrun of 700 to 1200(%), and a foam stability of 80 to 100(%).

4. The composition according to claim 1, wherein the aquafaba food composition is made by treating the legumes with the enzyme to cause a reaction, and maturing them for 1 to 20 days after the enzyme is reacted.

5. A method for production of aquafaba, comprising:
(step 1) a step of washing any one legume selected from the group consisting of chickpeas, black beans, small black beans (mouse-eye beans), soybeans and white kidney beans;
(step 2) a step of mixing water 3 to 7 times the weight of the legume with the legumes washed in step (1);
(step 3) a step of treating the water-mixed legume in step (2) with any one enzyme selected from the group consisting of \textcircled{1} a mixed enzyme of beta-glucanase, cellulase, hemicellulase and xylanase, \textcircled{2} a mixed enzyme of cellulase and hemicellulase, \textcircled{3} a xylanase enzyme, and \textcircled{4} a cellulase enzyme, in an amount of 0.1 to 2 wt. % relative to the weight of the legumes;
(step 4) a step of heating to 50 to 60 °C after treating the enzyme in step (3) above and reacting for 1 to 5 hours;
(step 5) a step of boiling by heating at 80 to 110 °C for 1 to 5 hours after reacting the enzyme in step (4);
(step 6) a step of maturing at 0 to 5 °C for 1 to 20 days after boiling in step (5);
(step 7) after maturation in the step (6), a step of adjusting to pH 4 to 5 by adding any one pH adjuster of phosphoric acid, tartaric acid, lactic acid, citric acid, and malic acid, and then, adding one or more thickener selected from the group consisting of xanthan gum, carrageenan, dextrin, guar gum, gellan gum, locust bean gum, pectin, MC, and HPMC at 0.1 to 0.5 wt. % to the final product;
(step 8) a step of producing aquafaba through steps (1) to (7) above; and
(step 9) a step of sterilizing the produced aquafaba at 110~130 °C and 1~2 atm for 30 minutes to 2 hours.
